(19) United States
(12) Patent Application Publication
(10) Pub. No.: US 2007/0048533 A1
(43) Pub. Date: Mar. 1, 2007

(54) Multi-layered surface protection for reinforced concrete in order to improve protection against corrosive for reinforced concrete constructions or reinforced concrete building components and method for the production thereof

(76) Inventors: Jochen Spriestersbach, Duisburg (DE); Frank Prenger, Ratingen (DE); Jurgen Wisniewski, Wesel (DE)

Correspondence Address: DARDI & ASSOCIATES, PLLC, 220 S. 6TH ST., SUITE 2000, U.S. BANK PLAZA, MINNEAPOLIS, MN, 55402, US

(21) Appl. No.: 10/561,804

(22) PCT Filed: Jul. 2, 2004
(86) PCT No.: PCT/EP04/07217

§ 371 Date: Jun. 26, 2006

(30) Foreign Application Priority Data
Jul. 3, 2003 (DE) 103 30 241.7

(51) Int. Cl. B05D 1/36; B05D 7/00; B05D 1/08; B32B 15/08

(52) U.S. Cl. 428/457; 427/421.1; 427/402; 427/446; 428/703

(57) ABSTRACT

A process for preparing a multilayer surface protection coating for reinforced concrete for improving the corrosion protection of reinforced concrete structures or reinforced concrete construction parts which bear a first layer sprayed onto said reinforced concrete, substantially made of zinc, which is connected with the metal armoring of said reinforced concrete in an electrically conductive way and a second layer of a polymeric material is characterized in that: said second layer of low-viscosity polymers is applied to said first layer of zinc in the form of a continuous film; and a surface protection layer is applied on top thereof. Further, there is disclosed a multilayer surface protection coating for reinforced concrete for improving the corrosion protection of reinforced concrete structures capable of bearing vehicles or reinforced concrete construction parts by layers present on the surface of said reinforced concrete, obtainable by the process according to the invention.

The present invention relates to a multilayer surface protection coating for reinforced concrete for improving the corrosion protection of reinforced concrete structures or reinforced concrete construction parts and to a process for the preparation thereof.

Corrosion of reinforced concrete structures is a frequently occurring phenomenon. Structures or construction parts affected by corrosion must be subjected to extensive reconstruction to prevent the corrosion from proceeding and, if possible, to revert the existing damage. Especially structures capable of bearing vehicles, which are subject to heavy mechanical and weathering influences, for example, in winter from thawing salt etc., are particularly susceptible to corrosion. Various methods are known for remedying corrosion damage or for applying a corrosion protection coating to reinforced concrete structures (see Handbuch der Brückenin-standhaltung, 2nd Ed., pp. 225ff., Vollrath, Tathoff; Verlag Bau+Technik, 2002).

DE 197 48 105 C1 relates to a process for improving the corrosion resistance of thermally applied sprayed layers of metal on reinforced concrete. A polyurethane resin is applied to the metal layer in such a way that no continuous film is formed to ensure the necessary water vapor permeability or exchange of gas. On the other hand, when further layers are built up, components may come into contact with the metal and in some cases undesirably interact with the metal. Further, the adhesion of overlying layers may not be sufficient.

The object of the present invention is to provide a process for improving the corrosion resistance of reinforced concrete parts and reinforced concrete structures built therefrom, and to provide reinforced concrete construction parts and related reinforced concrete structures which have an improved resistance to corrosion, avoiding the drawbacks of the prior art.

This object is achieved by a process according to claim 1. Dependent claims 2 to 13 relate to preferred embodiments of the process according to the invention. Claim 14 relates to a multilayer surface protection coating. Dependent claims 15 to 17 relate to preferred embodiments of the surface protection coating according to the invention.

The process according to the invention for preparing a multilayer surface protection coating for reinforced concrete for improving the corrosion protection of reinforced concrete structures or reinforced concrete construction parts which bear a first layer sprayed onto said reinforced concrete, substantially made of zinc, which is connected with the metal armoring of said reinforced concrete in an electrically conductive way and a second layer of a polymeric material is characterized in that:
said second layer of low-viscosity polymers is applied to said first layer of zinc in the form of a continuous film; and
a surface protection layer is applied on top thereof.

In one embodiment of the process according to the invention, said first layer of zinc is applied by thermal spraying.

To said first layer of zinc, a zinc alloy may be applied. Zinc alloys which may be used include, in particular, a zinc aluminum alloy with aluminum contents of up to 30% Al. The application of the zinc is effected by various spraying methods, for example, wire flame spraying or wire arc spraying. These methods differ, in particular, by different process temperatures and thus different application efficiencies. A typical layer thickness of the zinc layers is within a range of from 150 to 500 μm.

According to the invention, polyurethane resins or epoxy resins are employed as low-viscosity polymers for applying the second layer. Epoxy resins will adhere to the layer of zinc even in the absence of polyurethane base layers. It is to be taken care that a continuous film is formed.

To achieve a better adhesion between said at least second layer and the overlying surface protection layer, said at least second layer may be scattered with quartz sand. By applying said at least second layer, it is achieved that the pores are closed, and that the binder for applying the further layers is prevented from being absorbed. Further, the permeation of air, moisture and substances harmful to the coating, for example, alkaline components, from the substrates underlying the layers into the overlying layers is prevented. In addition, the substrate in the region close to the surface is strengthened, and a better bonding with subsequent layers is produced. Low-viscosity polymers are employed in order that solvent-based application can be omitted. This prevents the formation of bubbles or blisters, which would lead to an incomplete coverage with the low-viscosity polymer.

According to the invention, a surface protection layer is built on said at least second layer. The surface protection layer may be a sealing layer, a crack-bridging layer and/or a wear layer.

The surface protection layers serve one or more of the following functions:
water vapor permeability
carbon dioxide tightness
crack bridging
resistance to mechanical strain, such as wear resistance, and to imposed strains from temperature changes.

Basically, this results in three different types of surface protection layers, which may be met by one of the above mentioned layers.

Said sealing layer is made of plastic dispersions based on different polymers.

The crack-bridging property of a coating is achieved by elastification or sufficient thickness of the layer. Thus, in particular, elastomeric plastics, such as polyurethane, are employed. Optionally, the coating may be reinforced with textile inlays, especially of glass fiber fabric.

The wear layer is usually prepared from thermosetting materials, such as an epoxy resin. These layers usually serve none of the other functions mentioned, because their being worn corresponds to their intended purpose. Thus, as a rule, they are applied additionally if the surface is prone to heavy mechanical or chemical strains, for example, for bridge constructions or parking garages and other surfaces bearing vehicles. Usually, the sealing and crack bridging function is more frequently served by the layers lying below the wear layer. However, it is also possible to employ combined layers which are at the same time crack-bridging and wear-resistant. Such layers are usually made of mixed systems of elastomers and thermosetting materials and may be enriched with wear-resistant aggregates.

For reducing the soiling tendency and for a better integration of aggregates lying at the surface, especially fine grains, the wear layer may be provided with a cover or finish coating. The latter is typically made of thermosetting materials and is applied after the reaction of the wear layer is completed.

In the case of using bitumen welding sheets as the surface protection layer, the second layer may also be a cover sealing layer.

The invention relates to a multilayer surface protection coating for reinforced concrete for improving the corrosion protection of reinforced concrete structures or reinforced concrete construction parts by layers present on the surface of said reinforced concrete, obtainable by the process according to the invention.

The multilayer surface protection coating for reinforced concrete for improving the corrosion protection of reinforced concrete structures or reinforced concrete construction parts according to the invention bears on its surface a first layer of zinc, a second continuous layer of a polymeric plastic material and a surface protection layer.

In one embodiment of the invention, the surface protection layer is a sealing surface protection layer, a crack-bridging surface protection layer and/or a wear layer. A cover seal may be provided on top of the surface protection layer.

The invention is further illustrated by means of the following Example.

### EXAMPLE

A zinc layer having a thickness of about 300 μm (layer 1) was sprayed on reinforced concrete. To this substrate, a primer layer (layer 2) with a two-part epoxy coating material (Conipox 601, 0.3-0.5 kg/m²) was applied and scattered with quartz sand. Conipox 601 is sold by the Conica Technik A G, Schaffhausen, Switzerland. The quartz sand used for scattering has a grain size of from 0.3 to 0.8 mm and is applied at from 0.8 to 1 kg/m². To the primer layer, a third layer is applied as an elastic surface protection layer. Thus, a two-part polyurethane, such as Conipur 268 F (Conica Technik A G, Schaffhausen, Switzerland), is applied at from 2.1 to 2.5 kg/m². On top thereof, a wear-resistant cover layer of a two-part polyurethane (Conipur 267 F, Conica Technik A G, Schaffhausen, Switzerland), is applied at from 1.0 to 1.5 kg/m². This wear-resistant cover layer is scattered with quartz sand having a grain size of from 0.3 to 0.8 mm at from 3.0 to 5.0 kg/m². The cover seal as layer 5 is again formed from a two-part epoxy resin which is employed at from 0.5 to 0.8 kg/m² (Conipox 272, Conica Technik A G, Schaffhausen, Switzerland).

1-17. (canceled)

18. A process for preparing a multilayer surface protection coating for reinforced concrete for improving the corrosion protection of reinforced concrete structures or reinforced concrete construction parts comprising applying onto said reinforced concrete a first layer comprising zinc connected with metal armoring of said reinforced concrete in an electrically conductive way and applying a second layer comprising low-viscosity polymers to said first layer as a continuous film; and applying a surface protection layer on the second layer.

19. The process of claim 18 wherein the first layer is applied by thermal spraying.

20. The process of claim 18 further comprising a zinc alloy sprayed onto the first layer.

21. The process of claim 18 wherein the low-viscosity polymer is selected from the group consisting of polyurethane resins and epoxy resins.

22. The process of claim 18, wherein the surface protection layer is selected from the group consisting of a sealing layer, a crack-bridging layer a wear layer, and combinations thereof.

23. The process of claim 22 wherein the surface protection layer is a sealing layer comprising plastic dispersions based on different polymers.

24. The process of claim 22 wherein the surface protection layer is a crack-bridging layer comprising elastomeric plastics.

25. The process of claim 22 wherein the surface protection layer is a crack-bridging layer reinforced with a glass fiber fabric.

26. The process of claim 25 wherein the crack-bridging layer comprises elastomeric plastics made of polyurethane, epoxy or technically equivalent polymers.

27. The process of claims 22 wherein the surface protection layers is a wear layer comprising thermosetting materials.

28. The process of claim 27 wherein the thermosetting material comprises an epoxy resin.

29. The process of claim 18 comprising applying a cover sealing layer.

30. The process of claim 18 wherein the surface protection layer comprises bitumen welding sheets.

31. A process for preparing a multilayer surface protection coating for reinforced concrete for improving the corrosion protection of reinforced concrete structures or reinforced concrete construction parts comprising applying onto said reinforced concrete a first layer comprising zinc connected with metal armoring of said reinforced concrete in an electrically conductive way, and applying a cover sealing layer.

32. The process of claim 31 wherein the cover sealing layer comprises bitumen welding sheets.

33. A multilayer surface protection coating for reinforced concrete for improving the corrosion protection of reinforced concrete structures capable of bearing vehicles or reinforced concrete construction parts by layers present on the surface of said reinforced concrete comprising
a first layer comprising zinc connected with metal armoring of said reinforced concrete in an electrically conductive way,
a second layer comprising low-viscosity polymers in contact with the first layer as a continuous film, and
a surface protection layer on the second layer.

34. The multilayer surface protection coating of claim 33 wherein the surface protection layer is a sealing surface protection layer, a crack-bridging surface protection layer, a wear layer, or a combination thereof.

35. The multilayer surface protection coating of claim 33 wherein a cover seal is provided on the surface protection layer.

36. The multilayer surface protection coating of claim 33 wherein the surface protection layer comprises a cover seal.
